(19) United States
(12) Patent Application Publication
(10) Pub. No.: US 2014/0336803 A1
(43) Pub. Date: Nov. 13, 2014

(54) TIME MANAGEMENT AND TASK PERSISTENCE METHOD, APPARATUS AND SYSTEM

(71) Applicants: Keely Burke Haverstock, Palo Alto, CA (US); Jessica L. Bethune, Northridge, CA (US)

(72) Inventors: Keely Burke Haverstock, Palo Alto, CA (US); Jessica L. Bethune, Northridge, CA (US)

(21) Appl. No.: 14/340,240

(22) Filed: Jul. 24, 2014

(51) Int. Cl. G06F 3/16; G10L 13/04

(52) U.S. Cl. CPC G06F 3/165; G10L 13/04
USPC 700/94

(57) ABSTRACT

A time management system, method and apparatus is adapted to assist users in completing a series of routine tasks. The user generates a play list by entering a task transition, a task name, a task description, a song, and a task duration. A playback device plays the first task transition followed by playing the first song. The task transition can be a sound but is preferably a voice command. Upon completion of each song, a next task transition followed by an associated song are then played. The playback device ends the time management system upon completion of a last song.

### FIELD OF THE INVENTION

This invention relates to the field of managing time and maintaining focus on a series of tasks or actions. More particularly, this invention relates to a method, apparatus and system for selecting a series of songs or song clips, and presenting them in sequence to provide an audible trigger to proceed through the series of tasks.

### BACKGROUND OF THE INVENTION

There are many examples of routine tasks that consume portions of each person's day. These can include a wake up routine, a preparing for bed routine, a preparing to leave for work/school routine, a home cleaning routine, a work out routine among a myriad of other types of routines. After many repetitions of such routines, some people find it difficult to remain focused, motivated or on task to successfully or satisfactorily complete the routine.

### SUMMARY OF THE INVENTION

A time management system, method and apparatus is used to help in the performance of a series of routine tasks. The invention utilized an interface for entering a task play list. The playlist can include a task transition, a task name, a task description, a song; and a task duration. A playback device begins play of the play list by playing a first task transition followed by playing a first song. Upon completion of each song, the playback device plays a next task transition followed by an associated song. The playback device ends the time management system upon completion of a last song.

The task transition can be an audible indicator of time to begin a next task. The audible indicator can be a predetermined sound. Alternatively, the audible indicator can be a predetermined speech command. The speech command can be generated by a text-to-speech converter or be prerecorded.

The interface can operate on the playback device. Alternatively, the interface can operate on a network enabled device for entering the task play list, and further wherein the network enabled device is coupled for providing the task play list to the playback device.

In response to a parameter of a task intended to be performed, the playback device can alter the playback conditions. For example, the playback device adjust the volume of the song such as when the task intended to be performed is expected to be a loud task. Alternatively, the playback device can select another speaker such as in a different room when it is expected that a next intended task will take the user to a different venue.

### BRIEF DESCRIPTION OF THE DRAWINGS

FIG. 1 shows a schematic of a user performing a routine series of tasks according to the present invention.

FIG. 2 shows a sample entry page to the time management system of the present invention.

FIG. 3 shows a sample home page to the time management system of the present invention.

FIG. 4 shows a sample routine according to the time management system of the present invention.

FIG. 5 shows a sample for generating a new routine according to the time management system of the present invention.

### DETAILED DESCRIPTION OF THE PREFERRED EMBODIMENTS

When performing a series of routine tasks, a user is presented with a series of music performances that can be songs or instrumentals. Each performance can be a complete musical piece or a portion of such a piece conventionally called a clip. For ease of explanation, regardless of the type of music, song, instrumental, entire performance or clip, it will be referred to as a song hereinafter. To transition from a first task to a second task, the song changes from a first song to a second song. To transition from the second task to the third task, the song changes from the second song to a third song. This process repeats by changing songs to indicate a need to progress to the next tasks until the entire routine is complete.

By way of example, a programs for a wake up routine is presented to a user. A first song begins at a predetermined wake up time and plays for a first predetermined time to allow the user to stay in bed and check their email messages. Then, the song transitions to a second song which plays for a second predetermined time to allow the user to get out of bed, touch their toes and stretch, and walk into the bathroom. At this point, the song transitions to a third song which plays for a third predetermined time to allow the user to brush their teeth. Next, the song transitions to a fourth song which plays for a fourth predetermined time to allow the user to shower, rinse and dry off. Finally, the song transitions to a fifth song which plays for a fifth predetermined time to allow the user to return to their bedroom closet and dress for the day's activities.

The transition can simply be provided by the changing from one song to the next. Alternatively, the transition can be a task transition which is provided by the playing of an audio indicator, such as a chime, bird tweet, dog bark or any other convenient sound. Most preferably, the audio indicator for transition is an audible voice command such as “Now it is time to brush your teeth”. The voice command can be generated by a text-to-speech software algorithm. Alternatively, the voice command can be provided by selecting among pre-recorded commands. Still another alternative allows the user to record their own voice commands or have a friend, family member or acquaintance record the voice commands.

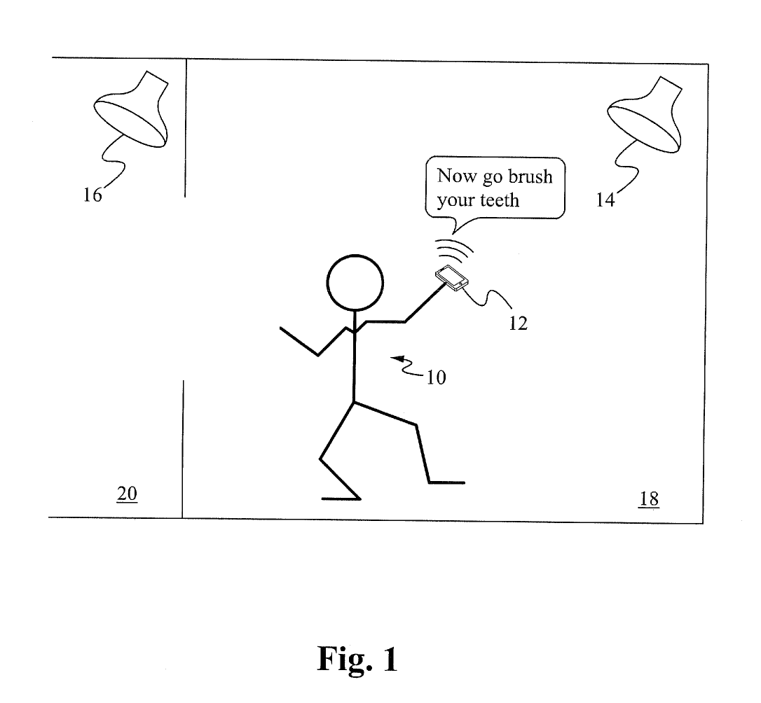

FIG. 1 shows a schematic diagram of a user 10 engaged in a routine series of tasks. The user's playback device 12 utters a task transition from its integral speaker, shown in the speech bubble. Alternatively, the playback device 12 could be wirelessly coupled to external speakers 14 to utter the task transition and play a song. As a further alternative, the playback device 12 could be coupled to control secondary speakers 16 in another room to draw the user from a first room 18 into a second room 20.

Some users will begin to associate a particular song with a particular task in their routine. When that occurs, users can choose to deactivate the audio indicator and allow only the song change to indicate the transition.

The series of routine tasks can be automatically invoked. This can occur by being controlled by an alarm clock routine. Ideally, a wake-up or morning routine would be automatically invoked. Other types of routine tasks can likewise be automatically invoked. Alternatively, the series of routine tasks can be selectively invoked. A work out routine might be undertaken at different times each day depending upon the user's other obligations or duties. In that regard, the routine can be manually invoked.

Preferably the series of song are presented by an appropriately programmed device or system. The program can be resident on a desktop, laptop, tablet computer, smart phone, music player such as an ipod Touch, or a single purpose electronic appliance. That device will include a storage that contains the songs selected for presenting during the routine. More preferably, the device will be coupled to a network such as the internet. The program can be a so-called web app, and the songs can be selected from free or commercial sources on the internet. in the routine are selected by the user.

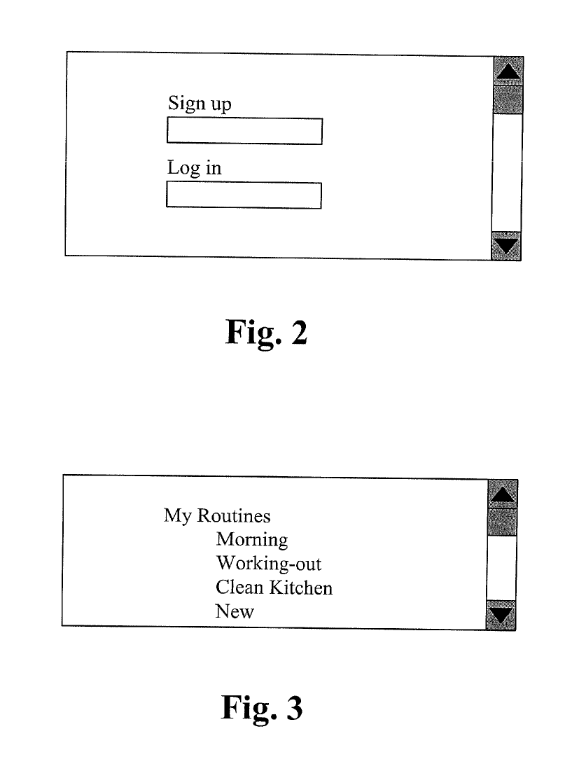

To generate the routine program, the user activates an interface, such as a graphical user interface (GUI). The GUI can reside on the playback device or be on another device and transmit or load the routine program to the playback device. Upon activating the program, the user is presented with a sign up or log in page. FIG. 2 shows an exemplary sign in/log in page. The image in FIG. 2 shows a sign up block into which a new user can enter their desired log in name in the usual manner. If the user already has an account, they can enter their log in name into the log in box to gain access. In the event the playback device is small, or additional information appears on the page, screen control is provided. FIG. 2 shows a conventional ‘elevator’ bar at the right to allow the user to scroll up or down. For touch screen devices, up/down control can be affected by swiping the screen in the desired direction, as is well known.

Upon activating or creating an account, the user is presented with their home page such as shown in FIG. 3. The user's routines are listed. If more routines have been generated than can be shown on the screen, the elevator or swiping can be used to display the desired routine. Depending upon the user interface technology present on the playback device, the user can activate a routine by clicking, tapping or highlighting/entering the appropriate routine. FIG. 3 shows that the routine “Morning” is highlighted. If the user desires to alter the routine, they simply activate the “Edit Routine” button.

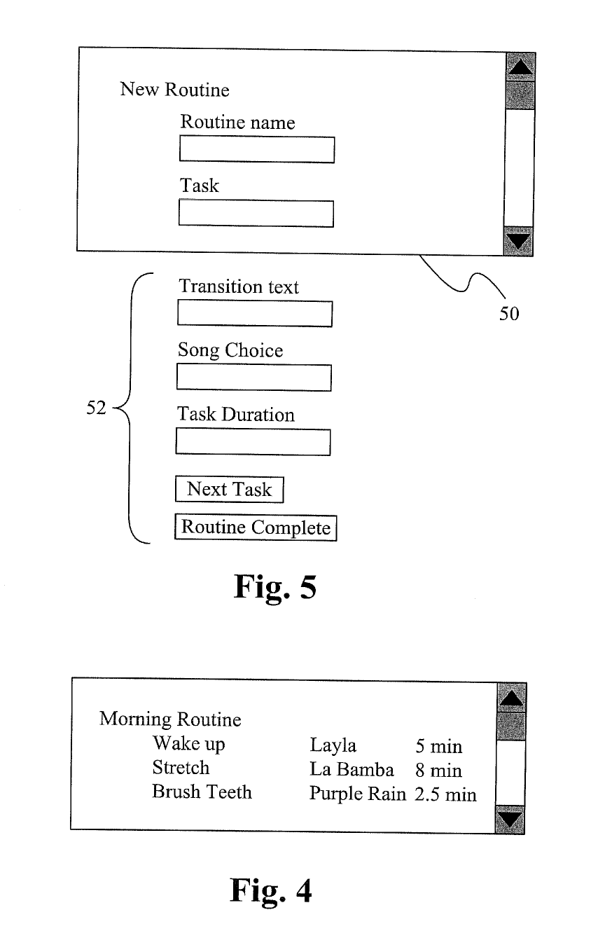

FIG. 4 shows one exemplary morning routine. The routine includes the task name, the song name and duration of each activity in the routine. Additional information can be displayed.

Preferably, one of the entries on the list of routines on the home page of FIG. 3 is “New”. By activating “New” the user can generate a new routine as shown in FIG. 5. The illustration of FIG. 5 shows a display screen 50 and additional information 52. That additional information and images thereof are accessed via the elevator shown at the right of the image or by swiping the screen in the appropriate direction. The user enters information into the appropriate text boxes for the name of the routine, the name of the task, the text for the task transition, the song choice, and the task duration. Other information can be included. When the task is fully entered, the user activates the “Next Task” button. When the full routine is entered, the user activates the “Routine Complete” button.

Through the interface, the user identifies the task, the song and the duration of play. In the case that an audio indicator is desired, the user can select the indicator, such as a chime. Alternatively, the user can activate the text for the text-to-speech converter to generate the transitional voice command or record the voice command with their own voice. In addition to voice commands, the user can enter motivational content, such as “great job” or “you're nearly finished.” To adjust the length of time, the song can be truncated for tasks that are shorter than the song. The truncation can simply end the song at a predetermined length, or select a section of the song of the desired length, such as with a slider bar interface. If the task is longer than the desired song, the program can re-start the selected song, or concatenate two or more songs together to reach the desired length for the task. Preferably, the user selects each song according to their preference. Alternatively, the program can select the song according to user parameters such as song length, desired tempo, musical genre and the like.

The songs can be selected from any music database resident on the device, or accessible to the device from a network. Music resident on the device can be there downloaded from CDs purchased by the user and ripped to the device, or purchased from a network site such as the iTunes store. Music accessible to the device from a network, can be acquired such as from the iTunes store, Spotify or other commercial music sites.

It will be apparent that certain tasks can be louder than others. For example, responding to emails is typically a quiet task, whereas showering or vacuuming can be loud. The interface can include a volume control to adjust the sound loudness according to the anticipated task.

The device can play music through integral speakers of their device, such as from a smart phone speaker. Alternatively, the device can be coupled to a speaker system, such as a pair blue tooth stereo speakers. The user can provide speakers in her bedroom and also her bathroom. The system can be controlled to play the songs in the bedroom when the tasks are intended to take place their and transfer to the bathroom, such as for tooth brushing and showering.

The digital appliance can be the user's smart phone, MP3 player, laptop, desktop computer, tablet computer or a special single-purpose appliance. The control system can reside on the appliance or be loaded onto the appliance from a network, such as the internet or cloud.

1. A time management system comprising:
a. an interface for entering a task play list, including:
i. a task transition;
ii. a task name;
iii. a task description;
iv. a song; and
v. a task duration;
b. a playback device for beginning play of the task play list including playing a first task transition followed by playing a first song;
c. upon completion of each song, the playback device is configured to play a next task transition followed by an associated song; and
d. the playback device is configured to end the time management system upon completion of a last song.

2. The time management system according to claim 1 wherein the task transition is an audible indicator of time to begin a next task.

3. The time management system according to claim 2 wherein the task transition comprises a predetermined sound.

4. The time management system according to claim 2 wherein the task transition comprises a predetermined speech command.

5. The time management system according to claim 4 wherein the predetermined speech command is generated by a text-to-speech converter.

6. The time management system according to claim 4 wherein the predetermined speech command is prerecorded.

7. The time management system according to claim 1 wherein the interface operates on the playback device.

8. The time management system according to claim 1 wherein the interface operates on a network enabled device for entering the task play list, and further wherein the network enabled device is coupled for providing the task play list to the playback device.

9. The time management system according to claim 1 wherein the playback device adjusts one of the volume of the song or selects a speaker or both in accordance with a parameter of a task intended to be performed.

10. A method of time management comprising:
a. generating a play list including the steps of:
i. entering a task transition;
ii. entering a task name;
iii. entering a task description;
iv. selecting a song; and
v. entering a task duration;
b. beginning play of the play list including playing the first task transition followed by playing the first song;
c. upon completion of each song, playing a next task transition followed by an associated song; and
d. ending the time management system upon completion of a last song.

11. The time management system according to claim 10 wherein the task transition is an audible indicator of time to begin a next task.

12. The time management system according to claim 11 wherein the task transition comprises a predetermined sound.

13. The time management system according to claim 11 wherein the task transition comprises a predetermined speech command.

14. The time management system according to claim 13 wherein the predetermined speech command is generated by a text-to-speech converter.

15. The time management system according to claim 13 wherein the predetermined speech command is prerecorded.

16. The time management system according to claim 10 wherein the interface operates on the playback device.

17. The time management system according to claim 10 wherein the interface operates on a network enabled device for entering the task play list, and further wherein the network enabled device is coupled for providing the task play list to the playback device.

18. The time management system according to claim 10 wherein the playback device adjusts one of the volume of the song or selects a speaker or both in accordance with a parameter of a task intended to be performed.
